(19) United States
(12) Patent Application Publication
(10) Pub. No.: US 2006/0134276 A1
(43) Pub. Date: Jun. 22, 2006

(54) Sulphur dioxide release coatings

(76) Inventors: William Potter, Stampleford (GB); Stephen Rawling, Sawston (GB); Joseph Brennan, Cambridgeshire (GB)

Correspondence Address: WALLENSTEIN WAGNER & ROCKEY, LTD, 311 SOUTH WACKER DRIVE, 53RD FLOOR, CHICAGO, IL, 60606, US

(21) Appl. No.: 10/538,517

(22) PCT Filed: Dec. 1, 2003
(86) PCT No.: PCT/GB03/05264

§ 371 Date: Dec. 16, 2005

(30) Foreign Application Priority Data
Dec. 10, 2002 (GB) 0228870.2

(51) Int. Cl. A23B 7/148

(52) U.S. Cl. 426/106

(57) ABSTRACT

There is disclosed a sulphur dioxide releasing film comprising: a hydrophilic polymer which is swellable upon contact with moisture; calcium sulphate or sodium sulphate; and a latent acidulant.

This invention relates to sulphur dioxide releasing films.

Perishable goods, such as foodstuffs, have a finite shelf-life due to various spoilage mechanisms, such as the activity of micro-organisms. There is great commercial advantage in preservation techniques for extending the shelf-life of such perishable goods.

It is known to inhibit spoilage by providing, in a suitable form, a precursor compound which can release sulphur dioxide on contact with moisture. European Patent Application EP 0 351 636 discloses packaging material comprising two sheets of material which are laminated together with a binding agent. The binding agent has dispersed therein a sulphur dioxide releasing material such as sodium metabisulphite. International Patent Application WO94/10233 discloses a wide range of single and multi-layer materials and polymeric films which are capable of releasing sulphur dioxide. However, there are a number of problems associated with the practical implementation of these films and materials. Firstly, the prior art composites release sulphur dioxide in a manner which is not controlled and which is not desirable for foodstuff preservation applications. In particular, sulphur dioxide release is spontaneous, with sulphur dioxide being released as soon as the composition is prepared. In contrast, it would be highly desirable to provide sulphur dioxide release systems which are stable on storage, only releasing the sulphur dioxide when activated by exposure to high humidity such as that caused by moisture release from foodstuffs. Loss of sulphur dioxide during manufacture and, more particularly, during storage significantly (or even totally) reduces the effectiveness of the preservation system. Secondly, prior art films have a tendency to mechanically break down, particularly when exposed to high humidity levels such as those encountered in the vicinity of foodstuffs.

The present invention addresses the above described problems, and provides improved sulphur dioxide releasing films which are mechanically stable, and possess excellent sulphur dioxide release characteristics.

According to a first aspect of the invention there is provided a sulphur dioxide releasing film comprising:

a hydrophilic polymer which is swellable upon contact with moisture;

calcium sulphite or sodium sulphite; and

a latent acidulant.

Films of this kind exhibit the advantages aforesaid. The latent acidulant is a compound or compounds that are converted into acids on contact with water, and thus supply hydrogen ions which accelerate the release of sulphur dioxide from the sodium sulphite or calcium sulphite. The release of hydrogen ions is phased over a period of time according inter alia to the kinetics of the reaction of the latent acidulant with water (which may be present as a liquid and/or as a vapour). It has been found that the above described combination of elements are key in order to produce films having commercially acceptable sulphur dioxide release properties. It has been found that, of the many sulphur dioxide releasing compounds suggested in the prior art, only calcium sulphite and sodium sulphite are acceptable, principally because it has been found that these compounds do not release sulphur dioxide spontaneously. In order to provide phased release of sulphur dioxide when it is wanted, ie, when moisture is present, it has been found to be essential that calcium sulphite or sodium sulphite is used in combination with a hydrophilic polymer and a latent acidulant. It has been found that favourable sulphur dioxide release profiles can be obtained, due to the interaction of the hydrogen ion release kinetics of the latent acidulant and the moisture sensitive release characteristics of the polymer.

WO94/10233 discloses a wide range of films incorporating a sulphur dioxide releasing compound (which can be selected from a large group of candidates) and one or more additives from the group: acid compounds, hygroscopic compounds, polymers which degrade to produce an acid, and compounds which become or generate an acid or acidic gas in a humid environment. Of the compounds which become or generate an acid or acidic gas in a humid environment, only generic examples are disclosed, and no further indication is provided of the identities of possible candidates. The present inventors have found that neither the specific examples nor the generic combinations provided in WO94/10233 are themselves adequate for practical usage. Furthermore, the present inventors have found that much improved films can be provided using a more specific combination of components. Further still, the present inventors have found that many of the components taught by WO94/10233 are in fact unsuitable for use in a practical sulphur dioxide releasing film. For example, sodium metabisulphite has been found to be highly unsuitable since sulphur dioxide is released spontaneously once the film is prepared.

The latent acidulant may comprise at least one anhydride. Lactones, lactides or other molecules that generate an acid group following a reaction with water may be used instead. Typically, the reaction will be hydrolysis, but alternative mechanisms are possible, for example via oxidation reactions such as oxidation of alcohol or carbonyl compounds. The latent acidulant may comprise at least one anhydride compound from the group comprising succinic anhydride, benzoic anhydride, itaconic anhydride and adipic anhydride. These compounds have been found to provide particularly good results. Surprisingly, succinic anhydride has been found to provide a dual usage as a latent acidulant and as a plasticiser for the polymer. The latter property enables the provision of films exhibiting improved mechanical properties, even in humid environments.

Preferably, the polymer comprises ethyl cellulose or cellulose acetate. WO94/10233 discloses an example of a film composition comprising a cellulose acetate film incorporating calcium sulphite. However, this example lacks the element of an anhydride latent acidulant (an organic acid being employed as an acidulant) and, as a consequence, displays sulphur dioxide release characteristics which are less satisfactory than those exhibited by films of the present invention. Also, the mechanical strength of the film is not sufficient to be of practical use. Furthermore, there is no suggestion in WO94/10233 that anhydrides of the type disclosed herein might be employed in order to produce improved sulphur dioxide releasing films.

Alternatively, the polymer may comprise a blend of a hydrophilic polymer with a hydrophobic polymer. An advantage associated with this approach is that a heat sealable film can be produced. The blend ratio is such that the polymer blend is hydrophilic and swellable upon contact with moisture. The hydrophobic polymer may comprise polyethylene and the hydrophilic polymer may comprise poly(ethylene oxide) or poly(vinyl alcohol-ethylene). Such polymer blends exhibit good mechanical properties and, importantly, good swelling properties.

The polymer may be capable of absorbing during swelling at least 2%, preferably at least 4%, most preferably about 10% water by weight of the polymer.

According to a second aspect of the invention there is provided a sulphur dioxide releasing article comprising a sulphur dioxide releasing film of the first aspect of the invention. The sulphur dioxide releasing article may comprise an article coated with the sulphur dioxide releasing film. Alternative ways of combining the film with the article might be employed, such as by heat sealing, or even by packaging the film with the article.

The article may be packaging material, such as a flexible sheet material or a container.

The article may be a foodstuff, which may be coated with the film.

Embodiments of films and articles in accordance with the invention will now be described with reference to the accompanying drawings, in which:

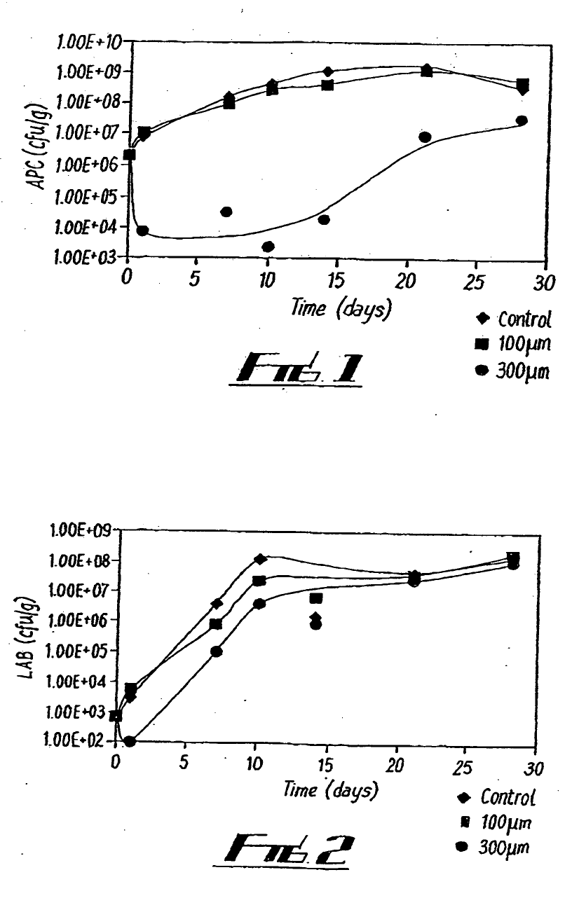

FIG. 1 shows total viable counts (TVC) as a function of time on pork steak samples;

FIG. 2 shows lactic acid bacteria counts as a function of time on pork steak samples;

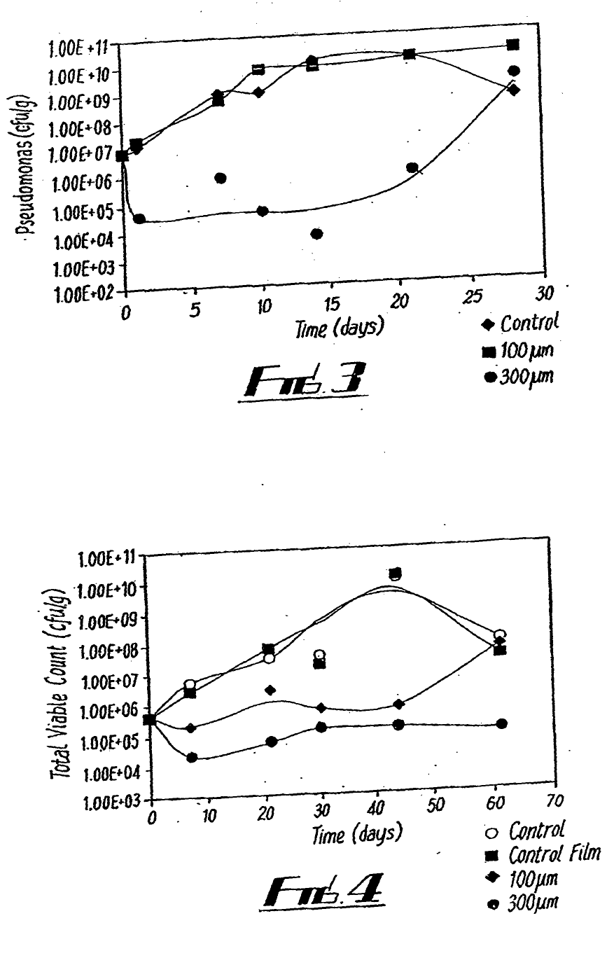

FIG. 3 shows pseudomonas spp. counts as a function of time on pork steak samples;

FIG. 4 shows total viable counts (TVC) as a function of time on vacuum packed pork slices;

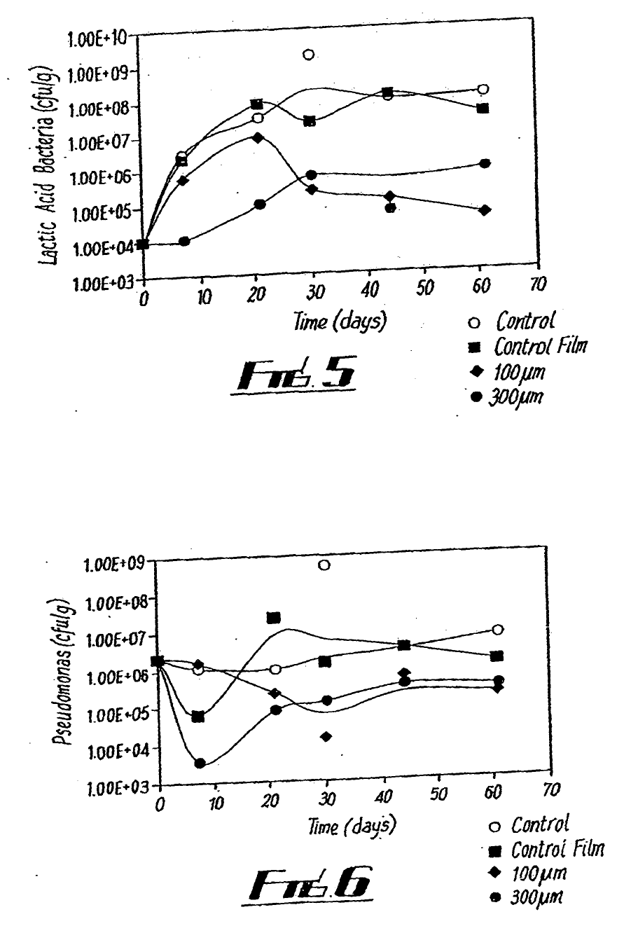

FIG. 5 shows lactic acid bacteria counts as a function of time on vacuum packed pork slices;

FIG. 6 shows pseudomonas spp. counts as a function of time on vacuum packed pork slices;

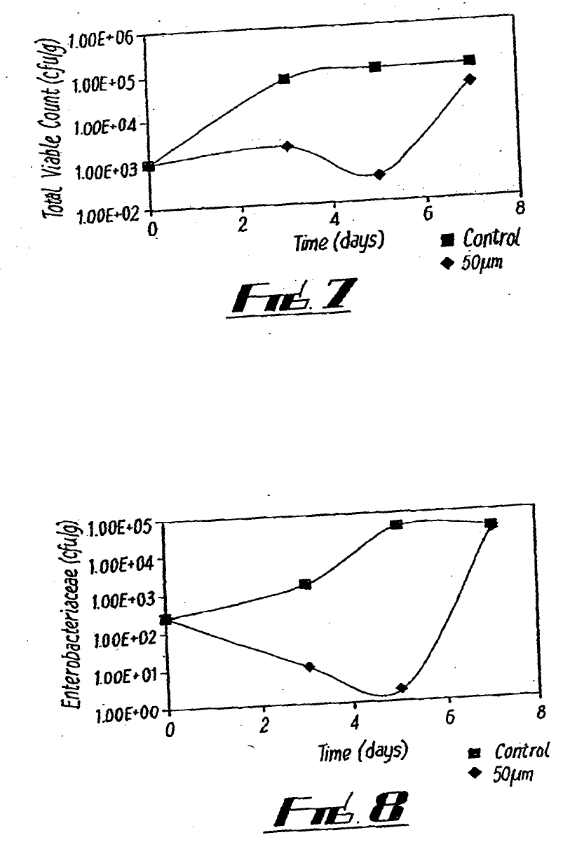

FIG. 7 shows total viable counts (TVC) as a function of time on strawberries;

FIG. 8 shows enterobacteriaceae counts as a function of time on strawberries;

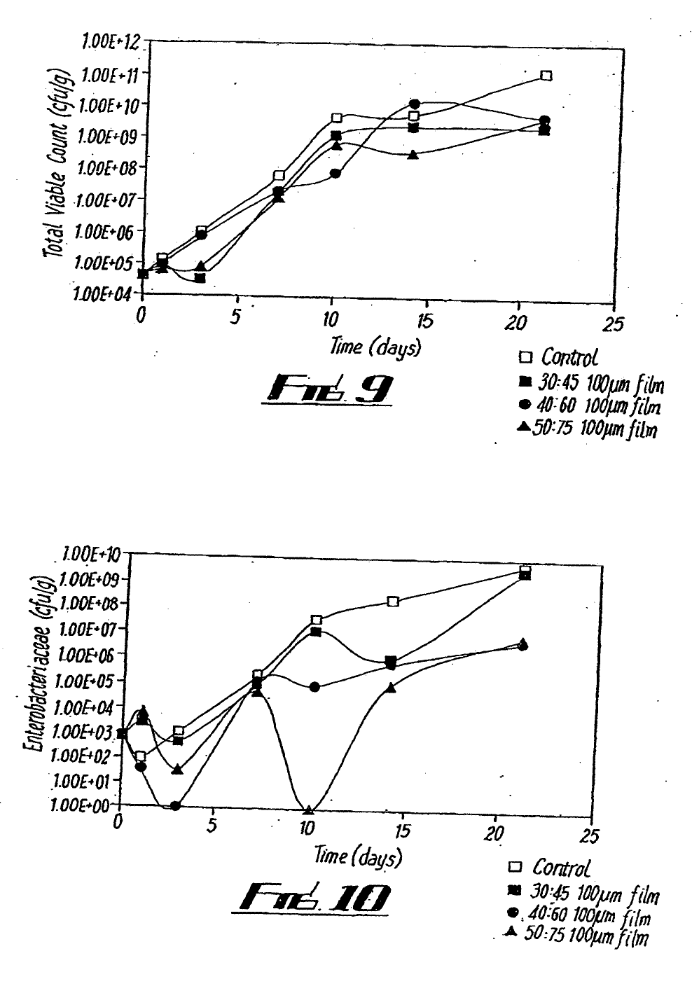

FIG. 9 shows total viable counts (TVC) as a function of time for 100 μm coated films on aerobic wrapped pork slices;

FIG. 10 shows enterobacteriaceae counts as a function of time for 100 μm coated films on aerobic wrapped pork slices;

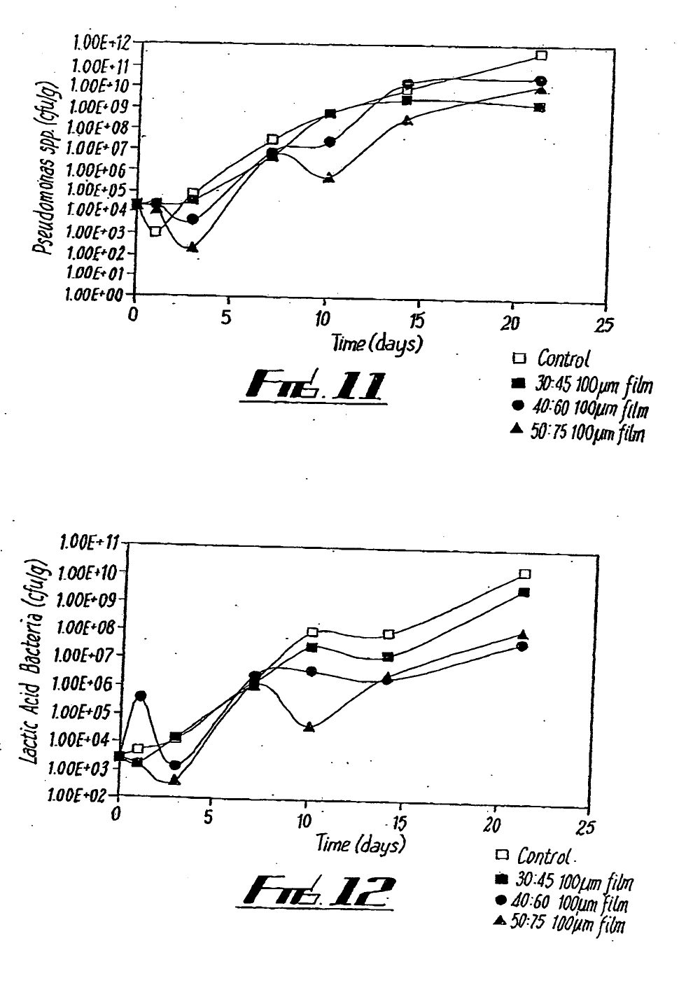

FIG. 11 shows pseudomonas spp. counts as a function of time for 100 μm coated films on aerobic wrapped pork slices;

FIG. 12 shows lactic acid bacteria counts as a function of time for 100 μm coated films on aerobic wrapped pork slices;

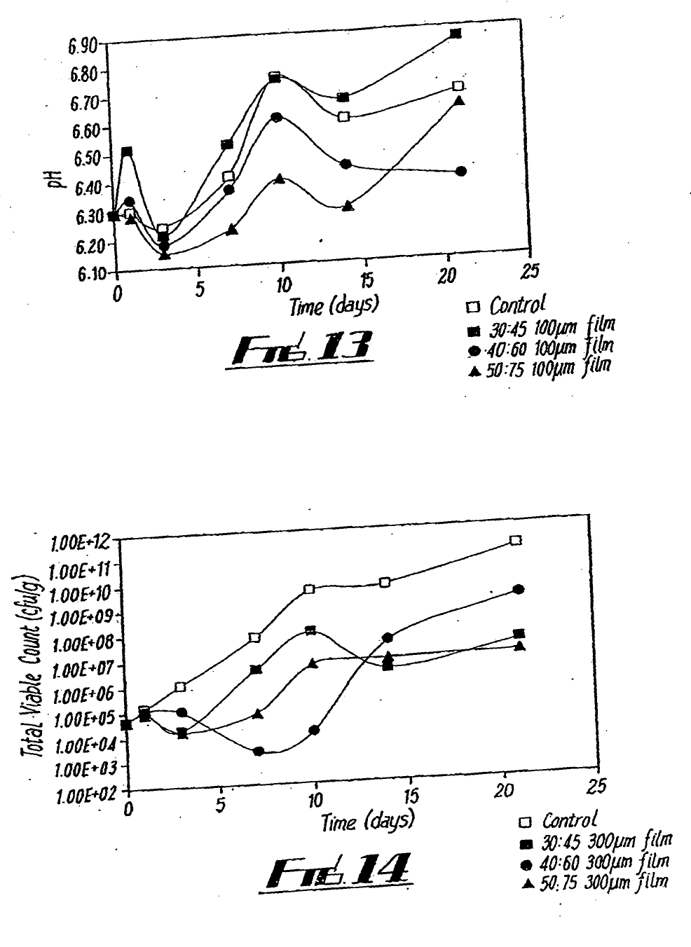

FIG. 13 shows the pH of the −1 dilution for 100 μm coated films on aerobic wrapped pork slices;

FIG. 14 shows total viable counts (TVC) as a function of time for 300 μm coated films on aerobic wrapped pork slices

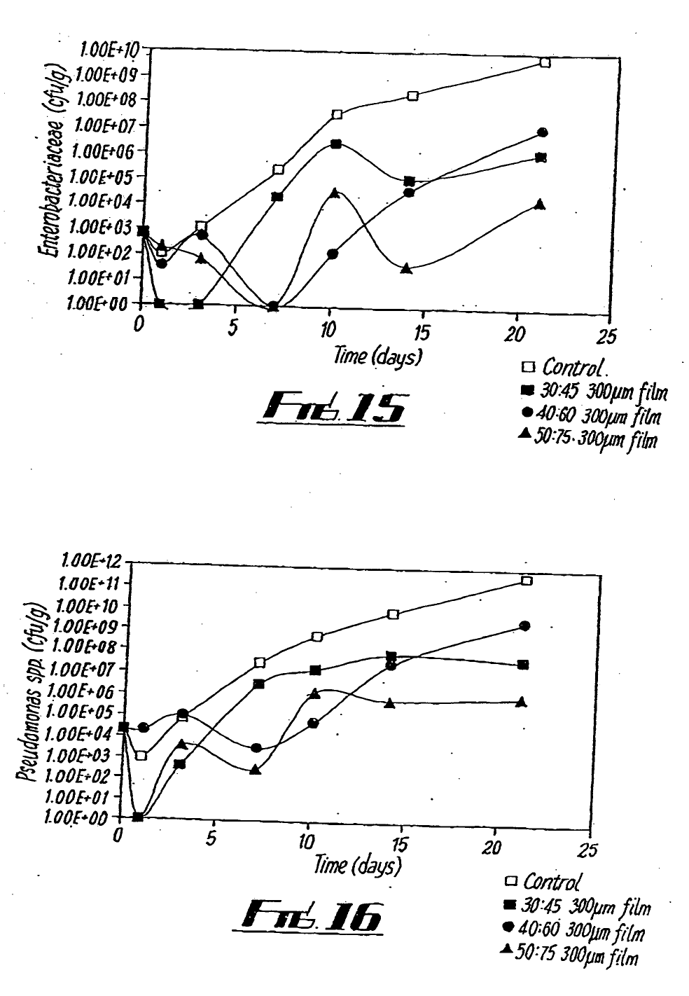

FIG. 15 shows enterobacteriaceae counts as a function of time for 300 μm coated films on aerobic wrapped pork slices;

FIG. 16 shows pseudomonas spp. counts as a function of time for 300 μm coated films on aerobic wrapped pork slices;

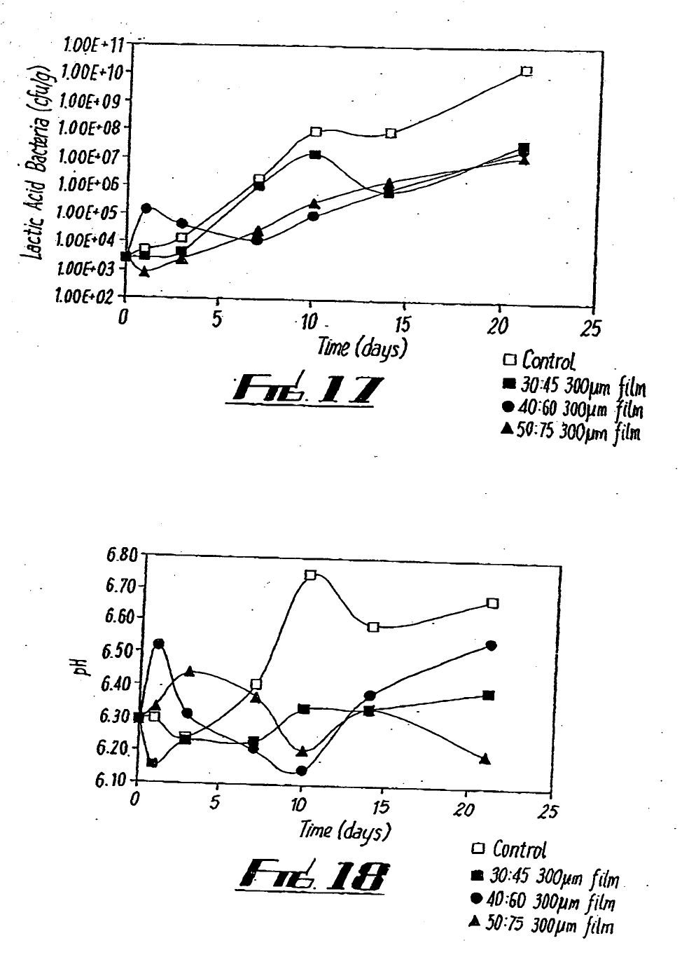

FIG. 17 shows lactic acid bacteria counts as a function of time for 300 μm coated films on aerobic wrapped pork slices; and

FIG. 18 shows the pH of the −1 dilution for 300 μm coated films on aerobic wrapped pork slices.

There are a number of problems which must be overcome in order to produce a practical and commercially viable sulphur dioxide releasing film. Firstly, desirable release characteristics must be achieved, so that sulphur dioxide is released in a phased manner once the film is in contact with a moist atmosphere such as that associated with food products. Furthermore, it is a prerequisite that very little or no sulphur dioxide is released under relatively dry storage conditions, such as extended warehouse storage. Secondly, the mechanical properties of the film must be commensurate with commercial use. In particular, many films crack and peel when in contact with moist food products. In a comparative example provided below, it is shown that the example film of WO94/10233 which displays greatest similarity to the films of the present invention exhibits some of the disadvantages discussed above.

A preferred polymer is ethyl cellulose. Ethyl cellulose exhibits good swelling properties of ca. 10% swelling. Such swelling on contact with water permits regulation of the sulphur dioxide release. Other swellable polymers are also suitable for use: for example, cellulose acetate, or polymer blends of polyethylene with poly(ethylene oxide) or poly(vinyl alcohol-ethylene).

Succinic anhydride, benzoic anhydride, itaconic anhydride or adipic anhydride are incorporated into the film. It is possible to utilise combinations of these anhydrides. The anhydrides act as latent acidulants. It is believed that the mechanism by which the anhydrides assist in the release of sulphur dioxide is via hydrolysis of the anhydride moiety to produce the corresponding organic acid. The organic acid liberates hydrogen ions which accelerate the hydrolysis of the sulphur dioxide releasing compound (either sodium sulphite or calcium sulphite). Thus, the kinetics of the release mechanism are very much favoured by the high relative humidity encountered within food packaging, and not favoured by dry storage conditions. An additional, and surprising, effect of the anhydride is to enhance the mechanical stability of the film by acting as a plasticiser. The effect is particularly marked with succinic anhydride. For example, it should be noted that ethyl cellulose coatings crack easily when spread without the anhydride additive. Such cracking was observed with pure ethyl cellulose coatings, and with ethyl cellulose coatings having sodium sulphite as an additive. The incorporation of various plasticising agents into such films did not provide a solution to the problem. However, films which incorporated succinic anhydride resulted in smooth and consistent coatings.

To avoid doubt, all of the anhydride and sodium sulphite or calcium sulphite concentrations referred to below are with respect to the dry weight of polymer.

In representative but non-limiting examples, a sodium sulphite or calcium sulphite concentration in the range 15 to 100%, preferably 25 to 80%, most preferably about 30% to about 75%, is used. The concentration of anhydride is generally in the range 10 to 100%. In the case of succinic anhydride, the concentration is generally in the range 10 to 50%, preferably 15 to 45%, most preferably about 30% to about 40%. When ethyl cellulose is used, a range of ethyl cellulose viscosities are suitable. Viscosities of 4 cps (centipose) to 300 cps have been successfully employed, with higher viscosities (generally viscosities greater than 150 cps) being preferred since improved mechanical properties are associated with the film. However, lower viscosity celluloses can be useful for applications in which the film is printed. The skilled person will appreciate that in addition to printing, many other coating methodologies might be employed, such as casting, moulding or extrusion. Cellulose films are generally produced by casting a solution of the relevant precursor dissolved in a suitable carrier, such as ethanol, followed by evaporation of the carrier. Preferred, but non-limiting, concentrations of ethyl cellulose (or cellulose acetate) in the carrier are in the range 5 to 30% w/w, with higher concentrations generally being preferred since enhanced sulphur dioxide release profiles, in which sulphur dioxide release is sustained over an extended period of time, can be obtained. The skilled reader will appreciate that the upper limited of the concentration for any given formulation is generally dictated by viscosity constraints.

Representative but non-limiting coating thicknesses are in the range 3 to 15 thousandths of an inch.

### EXAMPLE 1

A formulation comprising 20% succinic anhydride and 30% micronised sodium sulphite suspended in a 27% w/w ethyl cellulose/ethanol solution was produced. Low viscosity (4 cps) ethyl cellulose was employed. Coatings of 100 μm and 30 μm thickness were produced, corresponding to ca. 20 gm⁻² and 50gm⁻² of coating, respectively. Sulphur dioxide release was monitored by placing a 10 cm² piece of film and a sample of universal indicator paper in a sealed container under dry and wet conditions. Table 1 shows the results of an 85 day study. Table 1 indicates that under dry conditions, both coatings provide a neutral pH on the indicator paper, showing that no significant release of (acidic) sulphur dioxide occurs over the observed period of time. This is an important consideration from a commercial perspective since storage for an extended period would be expected. Furthermore, under wet conditions sustained sulphur dioxide release is observed, as evidenced by low observed pH values.

TABLE 1
pH values as a function of time for Example 1 films

| Coating | | DAY | | | | | | | | | | | |
|---|---|---|---|---|---|---|---|---|---|---|---|---|---|
| Thickness/μm | Conditions | 1 | 2 | 5 | 6 | 7 | 8 | 9 | 12 | 14 | 17 | 18 | 21 |
| 100 | Wet | 4 | 4 | 4 | 4 | 4 | 4 | 4 | 4 | 4 | 4 | 4 | 4 |
| 100 | Dry | 7 | 7 | 7 | 7 | 7 | 7 | 7 | 7 | 7 | 7 | 7 | 7 |
| 300 | Wet | 4 | 4 | 4 | 4 | 4 | 4 | 4 | 4 | 4 | 4 | 4 | 4 |
| 300 | Dry | 7 | 7 | 7 | 7 | 7 | 7 | 7 | 7 | 7 | 7 | 7 | 7 |

| Coating | | DAY | | | | | | | | | | |
|---|---|---|---|---|---|---|---|---|---|---|---|---|
| Thickness/μm | Conditions | 22 | 25 | 29 | 36 | 43 | 50 | 57 | 64 | 71 | 78 | 85 |
| 100 | Wet | 4 | 4 | 4 | 4 | 4 | 4 | 4 | 4 | 5 | 7 | 7 |
| 100 | Dry | 7 | 7 | 7 | 7 | 7 | 7 | 7 | 7 | 7 | 7 | 7 |
| 300 | Wet | 4 | 4 | 4 | 4 | 4 | 4 | 4 | 4 | 4 | 4 | 5 |
| 300 | Dry | 7 | 7 | 7 | 7 | 7 | 7 | 7 | 7 | 7 | 7 | 7 |

### EXAMPLE 2

Films were prepared using ethyl cellulose of different viscosities, namely 20, 100 and 300 cps ethyl cellulose. The polymer concentration was 11%. In each instance, films were produced comprising succinic acid and 30% sodium sulphite, and a wrapping trial was performed over a period of ten days. Qualitative analysis revealed that the film produced using 20 cps ethyl cellulose underwent mechanical breakdown within three days. Over the ten day period, small cracks were seen in the film produced using 100 cps ethyl cellulose. The film produced using 300 cps ethyl cellulose exhibited strong resistance to mechanical breakdown over a period of ten days.

### EXAMPLE 3

Films were produced using 300 cps ethyl cellulose in ethanol at various concentration levels. These films contained succinic anhydride and sodium sulphite in various concentrations. Details of the compositions of the films are shown in Table 2. Table 3 depicts the results of an eighteen day study into sulphur dioxide release under wet conditions using the pH measuring method generally described in Example 1. Films corresponding to a relatively low ethyl cellulose concentration of 6% provide relatively rapid sulphur dioxide release, with the supply of sulphur dioxide being virtually exhausted after five days. The rapid sulphur dioxide release appears to be independent of the amount of active ingredients (ie, anhydride and sulphur dioxide releasing material) present. It should be noted that in further tests performed in dry conditions, no sulphur dioxide was detected.

The film corresponding to an intermediate ethyl cellulose concentration of 8.5% displayed only a marginally extended sulphur dioxide release time profile in comparison to the low ethyl cellulose concentration films. The higher ethyl cellulose concentration films (in which 11% w/w ethyl cellulose in ethanol was used) exhibited sulphur dioxide release over a greatly extended period of fifteen days. The concentration of 11% is approaching the upper limit of ethyl cellulose concentration at the relatively high viscosity of 300 cps. Therefore, selection of the ethyl cellulose concentration used to produce the films permits control of the time profile for sulphur dioxide release.

TABLE 2
Key showing film formulations

| | Polymer Concentration | Succinic anhydride | Sodium sulphite |
|---|---|---|---|
| Coating | % | % | % |
| Fl | 6 | 30 | 45 |
| F2 | 6 | 40 | 60 |
| F3 | 6 | 50 | 75 |
| F4 | 6 | 60 | 90 |
| F5 | 8.5 | 20 | 30 |
| F6 | 11 | 20 | 30 |

TABLE 3
pH values obtained from films of Table 2

| Coating | Day | | | | | | | | |
|---|---|---|---|---|---|---|---|---|---|
| | 1 | 2 | 3 | 4 | 5 | 6 | 7 | 8 | 9 |
| F1 | 4 | 4 | | | 5 | 7 | Ceased | | |
| F2 | 4 | 4 | | | 5 | 7 | Ceased | | |
| F3 | 4 | 4 | | | 5 | 7 | Ceased | | |
| F4 | 4 | 4 | | | 5 | 7 | Ceased | | |
| F5 | 4 | 4 | | | 4 | 4 | 6 | 7 | 7 |
| F6 | 4 | 4 | | | 4 | 4 | 4 | 4 | 4 |
| | 10 | 11 | 12 | 13 | 14 | 15 | 16 | 17 | 18 |
| F1 | | | | | | | | | |
| F2 | | | | | | | | | |
| F3 | | | | | | | | | |
| F4 | | | | | | | | | |
| F5 | | | 7 | 7 | 7 | 7 | 7 | 7 | 7 |
| F6 | | | 4 | 4 | 4 | 4 | 5 | 6 | 6 |

### EXAMPLE 4

Preservative packaging is the most effective and acceptable means of prolonging the shelf-life of chilled meat. In aerobic environments Pseudomonas spp. are the most common spoilage organisms. Since they usually comprise part of the initial population on flesh food they are also widely distributed in the environment. Food spoilage due to Pseudomonads may occur in a number of ways. In meat, lipase and proteases liberate fatty and amino acids, which after metabolism by the organism result in off-odours, off-flavours and rancidity. At the later stages the production of extracellular slime and the development of growth, which is often pigmented, becomes visible. In this example ethyl cellulose films were prepared and shelf-life of pork chops wrapped in these films was then studied.

Films were produced using 27% w/w ethyl cellulose in ethanol with 20% succinic anhydride and 30% sodium sulphite, both loadings being a percentage value by dry weight of polymer. 4 cps ethyl cellulose was used, and films having coating thicknesses of 100 and 300 μm were produced.

Economy pork chops were obtained from a local supermarket and de-boned using sterile instruments. Individual slices approx. 1.5 cm thick and weighing ca. 90 g were wrapped in the films. These slices were then double wrapped in cling film. Controls were prepared using meat slices wrapped directly in cling film.

Samples were stored at <4° and removed at 0, 7, 10, 14, 21 and 28 days for microbial analysis. At each time interval one pack was sacrificed from the control, and film tests. Three samples of tissue of ca. 10 g weight were removed with sterile instruments from each pack. Each sample was homogenised with 9 times its weight in sterile ¼ strength Ringer's solution. Samples were decimally diluted as appropriate.

Total viable counts (TVC) were made on Plate Count Agar (PCA, Oxoid) at 30° C. for 48 h. Lactic acid bacteria were determined on de En, Rogosa, Sharpe agar (MRS) incubated at 30° C. for 48 h. Pseudomonas spp. were counted on Pseudomonas Agar Base (PAB, Oxoid) supplemented with cetrimiide fucidin cephaloridine (C-F-C, Oxoid) and incubated at 30° C. for 48 h.

Microbial analysis was performed in triplicate and the average values are shown in FIGS. 1, 2 and 3.

The data in FIGS. 1, 2 and 3 show the effects of 4 weeks of pork steak storage in films containing the active ingredients at the two coating levels.

The TVC lactic acid bacteria (LAB) and Pseudomonad profiles for the pork wrapped in cling film show no discernable lag phase and reach maximum cell populations in 10 days. The lactic acid bacteria initially represent 0.04% of the total population. At 10 days this has increased to 29% of the total cell population. However, the dominant species at 10 days are Pseudomonads.

The TVC, LAB and Pseudomonad profiles for the pork wrapped in 100 μm films are broadly similar to the control, although some suppression of growth is observed with the 100 μm film, particularly within the first 15 days. The TVC and pseudomonas counts for pork wrapped in 300 μm decreased 2.5 log cycles in the first 24 h and remained at this level for 14 days. An increase in TVC and Pseudomonas was observed after 14 days.

The only bacteria demonstrating growth with the 300 μm films were the lactic acid bacteria. This group of bacteria decreased 1 log cycles following the initial packing but subsequently increased. From Day 10 the growth rate declines in all packs (control, 100 μm and 300 μm) and they enter a stationary phase.

The pH of the meat at Day 28 in all cases is pH 6.7±0.1. This is a high pH for meat and indicates that Gram negative bacteria dominate. The microbial analysis confirms this since the pseudomonas spp. are 2-3 log cycles higher than the LAB. Meat dominated by LAB is normally pH 5.5-5.6

The Institute of Food Science and Technology recommended maximum value for raw meat is 10⁷ cfu/g. Above this value meat is considered unfit for human consumption. In this example the control pack rapidly exceeded this value (1-2 days) whilst the 300 μm packs did not reach this value for 21 days, extending the shelf-life by 20 days. This has been achieved by inhibition of Gram negative organisms such as Pseudomonas fragi and Alteromonas putrefaciens.

### EXAMPLE 5

The shelf-life of refrigerated meat may be extended to several weeks by vacuum-packing it in bags of plastic materials of low permeability to gases. These materials restrict the flow of gases to such an extent that the surrounding atmosphere of the meat becomes depleted in oxygen (often <1% v/v) and enriched in carbon dioxide (>20%). In these conditions the aerobic organisms responsible for the spoilage in refrigerated meat stored in air are inhibited by the carbon dioxide, and lactic acid bacteria (LAB) become the dominant group after storage. Other organisms such as Brochothrix thermosphacta and enterobacteriaceae have also been detected but their numbers are small.

Vacuum-packaging of meat is an established method of prolonging shelf-life and with good hygiene practice pork can be kept for up to 8 weeks under commercial conditions. Spoilage is normally evident in pork as ‘sour’, ‘cheesy’, or ‘acid’ off odours and flavours which have been attributed to short-chain fatty-acid end products of the dominant lactic acid bacteria. The shelf-life of vacuum packed meat with high pH (usually from stressed animals) is reduced due to discolouration (greening) and/or the production of objectionable ‘putrid’, ‘sulphury’ odours. These unpleasant spoilage characteristics are associated with the growth of Gram-negative organisms, particularly strands of Enterobacteriaeeae and Alteromonas putrefaciens, which may dominate along with lactic acid bacteria, or even outgrow the lactic acid bacteria.

Films of the same kind as described in Example 4 were produced and utilised in the manner described below.

A block of de-boned pork was obtained 72 h post slaughter. Individual pork slices approximately 1 cm thick and weighing approximately 90 g were wrapped in films of thicknesses of 100 μm and 300 μm. These slices were then inserted into Cryovac pouches (BBL4) and then vacuum packed and sealed. Controls were prepared using film with no active ingredient and meat slices packed directly into the plastic pouches.

Samples were stored at <4° C. and removed at 0, 7, 21, 30, 44 and 61 days for microbial analysis. At each time interval one pack was sacrificed from the Control, Control film, 100 μm and 300 μm 12 tests. Three samples of tissue of ca. 10 g weight were removed wit sterile instruments from each-pack. Each sample was homogenised with nine times its weight in sterile Ringer's solution (¼ strength). Samples were decimally diluted as appropriate. Total viable counts (TVC) were made on Plate Count Agar (PCA, Oxoid) at 30° C. for 48 h. Lactic acid bacteria were determined on de Man, Rogosa, Sharpe agar (NM) incubated at 30° C. for 48 h. Pseudomonas spp. were counted in Pseudomonas Agar Base (PAB, Oxoid) supplemented with cetrimide fucidin cephaloridine (C-F-C, Oxoid) and incubated at 30° C. for 48 h.

The average values for Total viable counts (TVC), Lactic acid bacteria (LAB) and Pseudomonas spp. are shown in FIGS. 4, 5 and 6. The data shown in these Figures demonstrates the effect of storing pork slices for 61 days in films containing the active ingredient at coating levels 100 μm and 300 μm under a vacuum packed environment.

FIG. 4 shows that bacterial growth was not inhibited by the micro-aerophilic environment in the Control or Control film vacuum packs, the growth reaching a maximum cell population of 10¹⁰ cfu/g at 44 days. In contrast growth was inhibited in 100 μm and 300 μm packs. The 100 μm film inhibits bacterial growth for 44 days whilst the 300 μm film continues to inhibit growth at 60 days where the final cfu/g is lower than the initial value.

The growth profiles for lactic acid bacteria in the Control and Control films are similar, reaching cell populations of 1×10⁸ cfu/g in 21 days. The LAB count increases in the packs containing the 100 μm and 300 μm pork slices up to 21 days and then declines. Growth of lactic acid bacteria in the 300 μm film packs extended the lag phase up to 7 days. Subsequent growth of LAB was slow with the cell population increasing by 2 log cycles at day 61.

The profile for Pseudomonas spp. is shown in FIG. 6. The trend for the Control and Control film packs indicates that vacuum packing extends the lag phase inhibiting pseudomonas growth. Pseudomonas species are aerobic and whilst the pack atmosphere has changed some oxygen remains following packing. Consequently Pseudomonas spp. may be able to survive in this micro-aerophilic environment but not increase their cell number.

The Pseudomonas profiles for the 100 μm and 300 μm film packs show a 1 log cycle decline by day 61. In the 100 μm film packs this decrease occurs up to 30 days after this period, the cell population remains stable. This could be a concentration effect or the development of a resistant population. The 300 μm film packs show a 2.5 log cycle decrease within 7 days, although a 1.5 log cycle increase is observed after 7 days. It is thought that the initial decrease is due to the increased loading of active ingredient in these films.

The Institute of Food Science and Technology recommended maximum value for raw meat is 10⁷ cf/g. Above this value meat is considered unfit for human consumption. In this study the Control and Control film packs exceeded this value within 20 days and the 100 μm packs at 61 days. The 300 μm packs did not reach this value, remaining 2 log cycles below this limit at 61 days. This indicates that films of the invention are effective in extending shelf-life in vacuum packed meat products.

### EXAMPLE 6

Films were produced using the following formulation:

Ethyl cellulose (300 cps)—11% w/w in ethanol;

Succinic anhydride—30% based upon dry weight of polymer;

Sodium sulphite—45% based upon dry weight of polymer.

Films of 50 μm thickness were produced.

Food grade paper samples were coated with films produced according to the above formulation.

Approximately 30 g of strawberries (25-40 g) were packed in plastic cups (250 ml). Paper coated with the film was then added and the cups covered with cling film. Control packs were prepared by omitting the coated paper prior to wrapping with cling film.

Samples were stored at room temperature and removed at 0, 3, 5 and 7 days for microbial analysis. At each time interval two packs were sacrificed from the Control, and coated paper tests. Approx. 10 g were removed with sterile instruments from each pack. Each sample was homogenized with 9 times its weight in sterile MRD. Samples were decimally diluted as appropriate.

Total viable counts (TVC) were made on Plate Count Agar (PCA, Oxoid) at 30° C. for 48 h. Enterobacteriaceae were determined on Violet Red Bile Glucose Agar (VRBGA, Oxoid) incubated at 37° C. for 48 h. Yeast and moulds were counted on Rose-Bengal Agar (RB, Oxoid) supplemented with chloroamphenicol and incubated at 30° C. for 72 h.

The average values for Total Viable Counts (TVC) and Enterobacteriaceae (Enteros) are shown in FIGS. 7 and 8.

FIG. 7 shows that bacterial growth was suppressed for up to 5 days. At day 7 the TVC has increased to a value similar to the control. In the control packs bacteria increase 2 log cycles in the first 3 days and remain at 10⁵ cfu/g thereafter. FIG. 8 shows the enterobacteriaceae profile. The enterobacteriaceae count decreases in the 50 μm film packs. However, as with the TVC, the number increases rapidly after day 5. This increase is probably due to the active ingredient falling below the MIC, allowing growth of surviving organisms.

### EXAMPLE 7

Films were coated with a formulation according to the invention which used 11% w/w ethyl cellulose in ethanol, with an ethyl cellulose viscosity of 300 cps. The coatings comprised succinic anhydride and sodium sulphite at concentrations 30:45, 40:60 and 50:75, (in which the succinic anhydride concentration is expressed first, the sodium sulphite concentrations expressed lastly, and all concentrations are percentages by weight of the dry weight of the polymer). Henceforth, a film having a succinic anhydride concentration of 30% and a sodium sulphite concentration of 45% will be referred to as a ‘30:45’ film, with this nomenclature being extended mutatis mutandis to films of other compositions. For each combination of succinic anhydride and sodium sulphite concentrations, coatings were produced of thickness 100 μm and 300 μm. Pork obtained from a local supermarket was cut into individual slices approx. 1 cm thick and weighing approx. 50 g. The slices were then wrapped in the coated films. These slices were then double wrapped in cling film. Controls were prepared using meat slices wrapped in uncoated film and double wrapped in cling film.

Samples were stored at <4° C. and removed at 0, 1, 3, 7, 10, 14 and 21 days for microbial analysis. At each time interval one pack was sacrificed from the control and coated films tests. Three samples of tissue of ca. 20 g weight were removed with sterile instruments from each pack. Each sample was homogenised with 9 times its weight in sterile MED. Samples were decimally diluted as appropriate.

Total viable counts (TVC) were made on Plate Count Agar (PCA, Oxoid) at 30° C. for 48 h. Enterobacteriaceae were determined on Violet Red Bile Glucose Agar (VRBGA, Oxoid) incubated at 37° C. for 48 h. Lactic acid bacteria was determined on de Man, Rogosa Sharpe agar (MRS) incubated at 30° C. for 48 h at Pseudomonas spp. were counted on Pseudomonas Agar Base (PAB, Oxoid) supplemented with cetrimide fucidin cephaloridine (C-F-C, Oxoid) and incubated at 30° C. for 48 h.

Microbial analysis was performed in triplicate and the average values are shown in FIGS. 9 to 18.

The Total viable counts (TVC), Enterobacteriacease, Pseudomonas spp. and Lactic acid bacteria for various coated films of 100 μm thickness are shown in FIGS. 9 to 12. Examination of the TVC profile shows that at Day 3 the control and 40:60 films are at or approaching the critical limit of 10⁷ cfu/g. At Day 3, the 30:45 and 50:75 films are approximately 1 log cycle lower than the control. However, by Day 7 all 100 μm coated films exceed the critical limit. Subsequent microbial growth follows the general trend displayed by the control, entering a stationary phase around Day 10 with new growth after Day 14.

The organisms inhibited by the 30:45 and 50:75 films include enterobacteriaceae, Pseudomonas spp. and Lactic acid bacteria. All these organisms show a decrease in cell number between Day 0 and Day 3. In all cases the dominant species remains Pseudomonas with LAB representing approx. 10% of the cell population.

FIG. 13 shows the pH of the −1 dilution for each of the 100 μm coated film test samples. The profiles follow the same general trend of initial decrease in pH (increase in acidity) followed by a rise in pH (increase in alkalinity). This pattern resembles the microbial growth profile. The change in pH from Day 3 to Day 10 increases as the succinic anhydride and sodium sulphite concentrations decrease.

The Total viable counts (TVC), Enterobacteriaceae, Pseudomonas spp. and Lactic acid bacteria for various coated films of 300 μm thickness are shown in FIGS. 14 to 17. Examination of the TVC profiles shows that bacterial growth was inhibited by all the films at this coating weight. At Day 7 only the 30:45 film has exceeded the 1.0×10⁶ cfu/g critical limit. A bacteriocidal effect is observed for Enterobacteriaceac and Pseudomonas spp. whilst a bacteriostatic effect is seen for LAB. This is strongly demonstrated in the 40:60 and 50:75 films where inhibition lasts for 7 to 10 days. The dominant species is Pseudomonas with LAB representing a maximum of 10% of the cell population.

FIG. 18 shows the pH of the −1 dilution for each of the 300 μm coated film samples. Whilst the profiles follow the same general trend exhibited by the 100 μm coated films, namely an initial decrease in pH (increase in acidity) followed by a rise in pH (increase in alkalinity), the rise in pH occurs later than that exhibited by the 100 μm coated films. This rise in pH signifies the end of the inhibition/lag phase and the emergence of Pseudomonas spp. as the dominant species. Whilst the inhibition phase is longer than that exhibited by the 100 μm coated films, the pH of the meat is not significantly lower.

Shelf-life extensions of up to 2 days were achieved with 100 μm coated films of composition 30/45 and 50/75. At the higher coating level of 300 μm, the shelf-life could be extended for 3 days with 30:45 and 7 days with 40:60 and 50:75.

### COMPARATIVE EXAMPLE 8

Example 1 of WO94/10233 is a cellulose acetate film having calcium sulphite and an organic acid as additives. A film was produced using the following constituents: cellulose acetate (10 g), acetone (100 ml), glycerol (1.2 g), sodium sulphite (5.0 g) and tartaric acid (6.25 g). Sodium sulphite is used in place of calcium sulphite owing to commercial availability: otherwise film corresponds to Example 1 of WO94/10233.

The formulation was prepared and cast in a similar way to the conditions described in WO94/10233. Once the single layer film had dried, a 10 cm² piece was placed into a sealed, dry jar with universal indicator paper. Within 0.5 h the pH was recorded at a value of 4. This clearly shows release of sulphur dioxide to be instantaneous without s need for any mechanism of initiation such as high relative humidity. Indeed, on continuation overnight the pH decreased to a value of 1-0 showing not only uninitiated release but very strong production of sulphur dioxide in an uncontrolled fashion. The sulphur dioxide release characteristics of this film render it unsuitable for any commercial purpose.

1. A sulphur dioxide releasing film comprising:
a hydrophilic polymer which is swellable upon contact with moisture;
calcium sulphite or sodium sulphite; and
a latent acidulant.

2. A film according to claim 1 in which the latent acidulant comprises at least one anhydride.

3. A film according to claim 2 in which the latent acidulant comprises at least one anhydride compound from the group comprising succinic anhydride, benzoic anhydride, itaconic anhydride, and adipic anhydride.

4. A film according to claim 1 in which the polymer comprises ethyl cellulose or cellulose acetate.

5. A film according to claim 1 in which the polymer comprises a blend of a hydrophilic polymer with a hydrophobic polymer.

6. A film according to claim 5 in which the hydrophobic polymer comprises polyethylene.

7. A film according to claim 5 in which the hydrophilic polymer comprises poly(ethylene oxide) or poly(vinyl alcohol-ethylene).

8. A film according to claim 1 in which the polymer is capable of absorbing during swelling at least 2%, preferably at least 4%, most preferably about 10% water by weight of the polymer.

9. A sulphur dioxide releasing article comprising a sulphur dioxide releasing film according to claim 1.

10. A sulphur dioxide releasing article according to claim 9 comprising an article coated with the sulphur dioxide releasing film.

11. A packaging material according to claim 9.

12. A foodstuff according to claim 9.
